(19) United States
(12) Patent Application Publication
(10) Pub. No.: US 2004/0255281 A1
(43) Pub. Date: Dec. 16, 2004

(54) Method and apparatus for improving translation knowledge of machine translation

(75) Inventors: Kenji Imamura, Soraku-gun (JP); Eiichiro Sumita, Soraku-gun (JP)

Correspondence Address: McDermott, Will & Emery, 600 13th Street, N.W., Washington, DC, 20005-3096, US

(73) Assignee: ADVANCED TELECOMMUNICATIONS RESEARCH INSTITUTE INTERNATIONAL

(21) Appl. No.: 10/840,391

(22) Filed: May 7, 2004

(30) Foreign Application Priority Data
Jun. 4, 2003 (JP) 2003-159662(P)

(51) Int. Cl. G06F 9/45

(52) U.S. Cl. 717/141; 717/136

(57) ABSTRACT

A method of improving translation knowledge includes the steps of preparing a set of translation knowledge, preparing a bilingual corpus of a source language and a target language, machine-translating sentences of the source language in the bilingual corpus to the target language using a set of translation knowledge, evaluating translation quality of the resulting translations in accordance with a prescribed evaluation standard, calculating degree of contribution to translation quality of a part of the translation knowledge, and removing the corresponding part of the translation knowledge when the calculated degree of contribution of the part is negative.

### BACKGROUND OF THE INVENTION

1. Field of the Invention

The present invention relates to an apparatus for forming translation knowledge for a machine translation apparatus that uses translation knowledge such as translation rules. More specifically, the present invention relates to a method and an apparatus for automatically forming a set of accurate translation knowledge, by improving translation knowledge including erroneous or redundant information such as translation knowledge automatically constructed from a training corpus through selecting/discarding information.

2. Description of the Background Art

Under the provision of 35 USC §119 (a), the present application claims priority on Japanese patent application No. 2003-159662 filed in Japan on Jun. 4, 2003, the entire contents of which are herein incorporated by reference.

Methods of machine translation include syntactic transfer method. According to the syntactic transfer method, mapping rules (translation rules) from words or phrases of a source language to a target language, as well as translation pairs, are prepared in advance. An input sentence of the source language is analyzed, and thereafter, the mapping rules and the translation pairs are applied to obtain a translated sentence in the target language. The most time-consuming task in constructing a machine translation system employing the syntactic transfer method is this formation (preparation) of the translation knowledge including such translation rules and translation pairs.

In the early days, the translation rules were prepared manually. However, with the advent of enhanced bilingual corpora, which are sets of translation pairs of the source and target languages, a method of automatically acquiring translation rules from a bilingual corpus are proposed. Automatic acquisition of translation rules would significantly reduce the amount of time and labor for constructing a machine translation system.

A plurality of methods of automatically acquiring translation rules from a bilingual corpus have been proposed. Such automatically acquired rules, however, have the following problems.

For instance, the conventional method of automatically constructing translation rules is less than impeccable, and the resulting translation rules are inherently liable to errors. By way of example, Imamura reported automatic extraction of aligned phrases as a basis for translation rules from a bilingual corpus in “Hierarchical phrase alignment harmonized with parsing,” Proceedings of the 6^{th} Natural Language Processing Pacific Rim Symposium (NLPRS2001), pp. 377-384, 2001, and noted that about 8% of equivalent phrases were erroneous. Application of such rules that are not error-free naturally leads to mistranslation.

Generally, there may be different translations of one source sentence. When a bilingual corpus includes such parallel bilingual translations, the diversity results in various and many redundant rules. Consequently, a plurality of mutually conflicting rules would be acquired.

For instance, when there are paraphrases, different translation rules are formed for each expression and, as a result, machine translation comes to have increased ambiguities. Increased ambiguities make it difficult to generate appropriate translation. In other words, paraphrases in a bilingual corpus lowers accuracy of machine translation.

When there are context-dependent translations or situation-dependent translations in the bilingual corpus, such translation rules that lead to excessive omission or generation of a spring-up word (word not found in the source language but generated in the translation) would be acquired. These translation rules may cause mistranslation.

Conventionally, the following two approaches have been proposed to address such redundant/conflicting rules. The first is to eliminate ambiguity by selecting an appropriate rule at the time of translation. The second is to sort out conflicting rules as a post-handling following automatic acquisition of translation rules, so as to select more relevant translation rules.

Proposals related to the above-described adjustment and optimization of conflicting rules in accordance with the second approach (hereinafter referred to as “cleaning of translation rules”) include Menezes and Richardson, “A best first alignment algorithm for automatic extraction of transfer mappings from bilingual corpora,” in Proceedings of the “Workshop on Example-Based Machine Translation” in MT Summit VIII, pp. 35-42, 2001, and Imamura, “Application of translation knowledge acquired by hierarchical phrase alignment for pattern-based MT,” in Proceedings of the 9th Conference on Theoretical and Methodological Issues in Machine Translation (TMI-2002), pp. 74-84, 2002.

According to the method proposed by Menezes et al., among the automatically acquired translation rules, only those of which frequencies of occurrences in identical patterns are not smaller than a prescribed number (for example, 2) are adopted. This method is based on the appearance frequency of the rule. According to the method proposed by Imamura (2002), hypothesis testing using χ-square test is conducted on only the patterns that appear frequently, and only the translation rules having statistically high reliability are extracted.

Menezes et al. reports that by their method, the number of rules are reduced to about 1/9 after cleaning, and translation quality is slightly improved. Improvement in translation quality, however, does not match up to the significant reduction in the number of redundant rules.

According to the method proposed by Imamura (2002), the number of rules obtained as statistically reliable is small as compared with the size of the corpus. Therefore, in order to obtain sufficient number of rules, a broad coverage corpus must be prepared. Unfortunately, however, there is not yet such a broad coverage corpus that allows preparation of sufficient number of statistically reliable rules for machine translation.

### SUMMARY OF THE INVENTION

Therefore, an object of the present invention is to provide method and apparatus for improving translation knowledge allowing improvement in translation quality, by improving translation knowledge such as translation rules automatically acquired from a bilingual corpus.

Another object of the present invention is to provide method and apparatus for improving translation knowledge allowing improvement in translation quality, by improving translation rules automatically acquired from a bilingual corpus of a common scale.

A further object of the present invention is to provide method and apparatus for improving translation knowledge allowing improvement in translation quality, by cleaning, in a relatively short time period, translation rules automatically acquired from a bilingual corpus of a common scale.

According to a first aspect, the present invention provides a method of improving translation knowledge for machine translation from a first language to a second language, using a computer. The method includes the steps of: preparing, in a storage device, a set of computer-readable translation knowledge; preparing, in a storage device, a bilingual corpus including a plurality of computer-readable translation pairs of the first and second languages; machine-translating each of the sentences of the first language in the bilingual corpus to the second language using the set of translation knowledge; automatically evaluating translation quality of the second language obtained as a result of the machine-translation step, in accordance with a prescribed evaluation standard with reference to the bilingual corpus, to calculate an evaluation value; calculating, for a subset of the set of translation knowledge, degree of contribution of the subset of interest to the translation quality, using record of the translation knowledge used for translation of each sentence in the machine-translation step and using the evaluation value; and removing, from the set of translation knowledge, translation knowledge having a prescribed relation with the subset, when the degree of contribution calculated by the step of calculating degree of contribution satisfies a predetermined condition.

A subset of translation knowledge is selected, and machine translation is performed using the translation knowledge including and not including the said translation knowledge. Qualities of resulting translations are compared, and the degree of contribution of the translation knowledge of interest on the quality of machine translation is calculated. The translation knowledge is removed in accordance with the degree of contribution. As a result, it becomes possible to reduce the amount of translation knowledge abundant in unnecessary knowledge and erroneous knowledge that are the cause of lower translation quality, and to improve the translation quality.

(A) The step of calculating degree of contribution may include the step of calculating difference between the evaluation value calculated in the step of calculating the evaluation value and an evaluation value of translation quality when each of the sentences of the first language in the bilingual corpus is translated using a complementary set of the subset related to the set of translation knowledge.

Preferably, the step of machine-translation includes the step of translating, using a set of translation knowledge, each of the sentences of the first language in the bilingual corpus to the second language while generating a record of the translation knowledge used for translating each sentence. The step of calculating difference may include the steps of: based on the record of the translation knowledge used for translating each sentence generated in the step of machine-translation, identifying sentences of the first language translated using the translation knowledge included in the subset in the step of machine-translation and corresponding translations translated in the step of machine-translation; re-translating each of the sentences of the first language identified in the identifying step, by machine-translation using translation knowledge included in the complementary set of the subset related to the set of translation knowledge; calculating a re-evaluation value by automatically evaluating, in accordance with a prescribed evaluation standard, a set of translations obtained by replacing the translations of the first language identified in the identifying step with the translations resulting from the re-translation step in the set of translations obtained by the step of machine-translation; and calculating a difference between the evaluation value calculated in the step of calculating evaluation value and the re-evaluation value calculated in the step of calculating re-evaluation value.

Re-translation may be done using translation knowledge with certain translation knowledge removed, and the resulting evaluation value may be calculated. In that case, however, computation load would be significantly increased. By recording translation knowledge used for translation of each sentence at the time of first translation, it becomes possible to identify the sentence of which translation result differs when a certain translation knowledge is removed. By re-translating only such a sentence and replacing the first translation, evaluation result comparable to that of full re-translation can be attained. As a result, translation knowledge can be improved with smaller amount of computation.

The present method may further include the steps of: forming, from a computer readable training corpus including translation pairs of the first and second languages prepared in advance, a plurality of sub-corpus pairs each including a training sub-corpus and an evaluation sub-corpus; automatically constructing translation rules from each of the plurality of sub-corpus pairs, in accordance with a predetermined method of constructing translation rules; storing, in a storage device, a set of a plurality of translation rules constructed for the plurality of sub-corpus pairs in the constructing step, as basic translation knowledge for the plurality of sub-corpora; performing, for each of the plurality of sub-corpus pairs, using each of the plurality of sub-corpus pairs as the bilingual corpus and using the set of translation rules obtained in the step of constructing from the corresponding sub-corpus as translation knowledge, the steps of preparation, machine-translation, calculating evaluation value, calculating degree of contribution and removal, so as to improve translation knowledge; and merging sets of translation knowledge obtained for each of the plurality of sub-corpus pairs improved in the step of improving translation knowledge, to one set of translation knowledge.

The method of improving the translation knowledge in this manner is referred to as “cross cleaning.” Cross cleaning reduces the possibility of erroneous translation knowledge being left.

According to a second aspect, the present invention provides a storage medium storing a computer program controlling a computer such that when the program is executed by the computer, all the steps of each of the above-described methods are executed.

According to a third aspect, the present invention provides a translation knowledge improving apparatus that improves translation knowledge for machine translation. The apparatus includes: a translation knowledge storing unit for storing a set of translation knowledge; a corpus storing unit for storing a machine readable bilingual corpus including a plurality of translation pairs of a source language and a target language; a machine translation engine for machine-translating sentences of a source language in the bilingual corpus to the target language, using the set of translation knowledge stored in the translation knowledge storing unit; a translation quality automatic evaluation unit for automatically evaluating translation quality of the result of translation by the machine translation engine with reference to the bilingual corpus; and an improving unit for improving the set of translation knowledge such that the evaluation value output from the translation quality automatic evaluating unit changes desirably.

Translation quality of the result of machine translation using the translation knowledge is automatically evaluated. The set of translation knowledge is improved such that the evaluation value changes as desired. Thus, the set of translation knowledge can be improved to attain translation result of higher quality.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of a translation rule extracting apparatus 20 in accordance with a first embodiment of the present invention.

FIG. 2 shows exemplary translation rules.

FIG. 3 shows an appearance of a computer implementing translation rule extracting apparatus 20.

FIG. 4 schematically shows a circuit configuration of the computer shown in FIG. 3.

FIG. 5 is a flow chart representing a control structure of a program for implementing, by a computer, translation rule extracting apparatus 20 in accordance with the first embodiment.

FIG. 6 is a schematic illustration of the cross cleaning method in accordance with a second embodiment of the present invention.

FIG. 7 is a functional block diagram of translation rule extracting apparatus 180 in accordance with the second embodiment of the present invention.

FIG. 8 is a flow chart representing a control structure of a program for implementing, by a computer, translation rule extracting apparatus 180 in accordance with the first embodiment.

### DESCRIPTION OF THE PREFERRED EMBODIMENTS

Embodiments of the present invention will be described in the following. In the following description, corresponding portions will be denoted by the same reference characters. Functions are also the same. Therefore, detailed description thereof will not be repeated. For simplicity of description, a list of references is appended at the end of the description of preferred embodiments, and in the specification, the references will be identified by the numbers in the list.

In the following, first and second embodiments will be described. The basic concept common to these embodiments is as follows. In the embodiments of the present invention, redundant/conflicting rules are processed using the second approach described above. For this purpose, sentences of a source language in an evaluation corpus are machine-translated using automatically constructed translation rules. Translation quality of the machine-translated result is automatically evaluated using a tool such as described in Reference 1, to obtain an automatic evaluation value. The translation rules are selected or discarded such that the automatic evaluation value is improved, and a combination of optimal translation rules (a set of optimal translation rules) is obtained.

In the embodiments described in the following, the hill-climbing method is used for combining the optimal translation rules. Here, the automatic evaluation value obtained for each combination is regarded as an output of an evaluation function.

Particularly, in the following embodiments, only the removal of rules is performed on the automatically constructed set of translation rules. As the operation is limited to removal only, the speed of cleaning process can be increased.

In the embodiments described in the following, optimization of the set of translation rules for translating English to Japanese will be discussed as an example. The present invention, however, is not limited to such a combination of languages, and the invention is applicable to any combination of languages that can be translated by applying the translation rules.

### First Embodiment

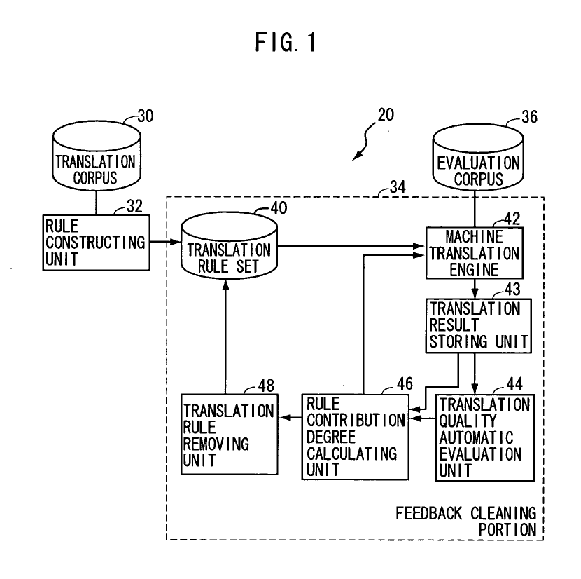

FIG. 1 is a functional block diagram of a translation rule extracting apparatus 20 in accordance with a first embodiment of the present invention. Referring to FIG. 1, translation rule extracting apparatus 20 includes: a training corpus 30 containing a large number of translation pairs of a source language (English) and a target language (Japanese); a rule constructing unit 32 for automatically constructing machine translation rules from training corpus 30; a feedback cleaning unit 34 for performing a feedback cleaning process as will be described later, on the set of translation rules constructed by rule constructing unit 32; and an evaluation corpus 36 referred to by feedback cleaning unit 34 at the time of feedback cleaning, for evaluating translation quality. Translation pairs in evaluation corpus 36 include source sentences in English and results of manual translation of the source sentences (referred to as reference translation).

Feedback cleaning unit 34 includes a translation rule set storing unit 40 for storing a set of translation rules automatically constructed from training corpus 30 by rule constructing unit 32, and a machine translation engine 42 for translating all the source sentences in English in evaluation corpus 36 to sentences of a target language using the translation rules stored in translation rule set storing unit 40. Machine translation engine 42 is of syntactic transfer type.

Feedback cleaning unit 34 further includes a translation result storing unit 43 for storing result of translation by machine translation engine 42 together with information identifying a translation rule used for translating each sentence.

Feedback cleaning unit 34 additionally includes a translation quality automatic evaluating unit 44 for automatically evaluating quality (translation quality) of sentences in Japanese (translated sentences) stored in translation result storing unit 43, using evaluation corpus 36, and a rule contribution degree calculating unit 46 for calculating, for each rule contained in translation rule set storing unit 40, automatic evaluation value after removal of the rule and calculating difference from the automatic evaluation value before removal (here, the difference will be referred to as “rule contribution degree” of the rule). Rule contribution degree calculating unit 46 uses, for calculation of the degree of contribution, the evaluation value provided by translation quality automatic evaluating unit 44 and the information identifying the translation rule used at the time of translation, stored in translation result storing unit 43.

Feedback cleaning unit 34 further includes a translation rule removing unit 48 for removing, from the set of translation rules in translation rule set storing unit 40, among the translation rules, a translation rule of which rule contribution degree calculated by contribution degree calculating unit 46 satisfies a prescribed condition (in the present embodiment, a translation rule of which rule contribution degree is negative).

In the present embodiment, a method proposed by Imamura (2002) described above is used for automatic construction of translation rules by rule constructing unit 32.

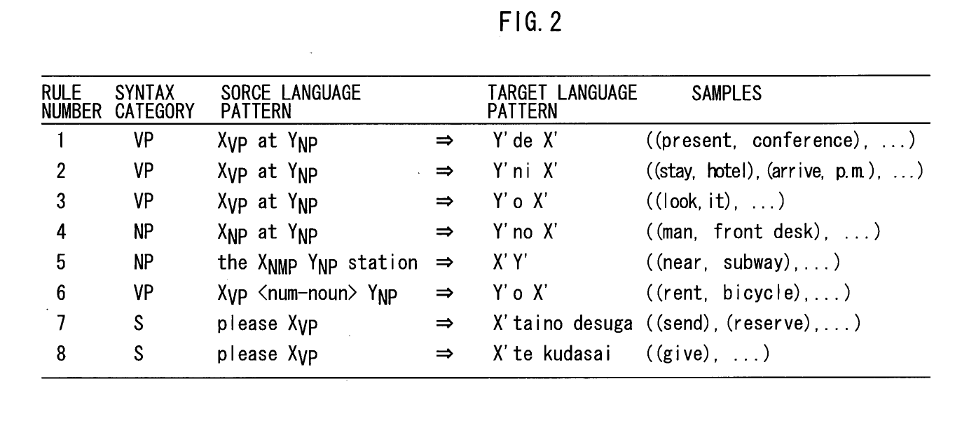

In the present embodiment, as machine translation engine 42, one described in Reference 2, which is of the syntactic transfer type, is used. Machine translation engine 42 uses translation rules for transferring syntax structure of English to syntax structure of Japanese. FIG. 2 shows exemplary translation rules employed by machine translation engine 42. In this example, one rule includes a syntax category, a source language pattern, a target language pattern, and a sample or samples.

The syntax category represents a category of an English syntax node to which the rule is applied. The source language pattern represents a pattern of an English syntax structure to which the rule is applied. The source language pattern is a string of non-terminal symbols (variables) such as X, Y, and a terminal symbol such as a word or a marker.

The target language pattern represents a pattern of a Japanese syntax structure generated when the rule is applied. It is a string of variables (X′, Y′ and the like) corresponding to the source language pattern and a terminal symbol represented by a word.

The sample represents an actual sample of the variable that appears in the training corpus, and it is a set of head words of which number is equal to the number of variables. Samples of respective rules in translation rule set storing unit 40 of the present embodiment are examples appearing in training corpus 30.

The translation rules stored in translation rule storing unit 40 are in accordance with a format of translation rules used by machine translation engine 42.

Among the rules shown in FIG. 2, rule No. 1, by way of example, is applied to an English phrase of “present at the conference,” for generating a translation “kaigi (translation of ‘conference’) de happyosuru (translation of ‘present’)”.

As translation quality automatic evaluating unit 44, BLEU described in Reference 4 is used. Methods of automatically evaluating machine translation such as BLEU have been proposed. These methods are proposed for increasing speed of machine translation development cycle, by replacing conventional manual/subjective evaluation with automatic evaluation. As the evaluation is fully automatic, such a method can be used not only for the originally intended development assisting process but also for automatic tuning of a translation system, as in the present embodiment.

BLEU used for automatic evaluation of translation quality in the present embodiment calculates similarity between the result of machine translation of source sentences of the evaluation corpus by machine translation engine 42 and the reference translations in evaluation corpus 36, and outputs the translation quality as a score (BLEU score). Similarity is measured by the number of N-gram matching between the two. The value N is variable, and in the present embodiment, 1-gram to 4-gram are used.

It is noted here that in order to use the BLEU score for evaluating a set of machine translation rules as in the present embodiment, it is necessary to use a sentence set of a certain size. Though it is possible to calculate the BLEU score sentence by sentence, such score as it is would be much deviated from subjective evaluation. By calculating individual similarity for overall translations included in the set of translation results and by calculating total sum, individual error can be offset.

Rule contribution degree calculating unit 46 calculates the degree of contribution rule by rule in the following manner. First, for the translation results of all the sentences of the source language in evaluation corpus 36 by machine translation engine 42, an automatic evaluation value as a standard is obtained, using the score calculated by machine translation engine 42. This value will be referred to as automatic evaluation value before removal. Here, information as to which rule is used for translating which sentence is also obtained.

Thereafter, for every rule among the translation rules in translation rule set storing unit 40, a score is calculated assuming that all the sentences in the source language of evaluation corpus 36 are translated using a subset obtained by removing the rule of interest from translation rule set storing unit 40. The difference between the score and the automatic evaluation value before removal is the degree of contribution of the rule. In the present embodiment, calculation of the score after removal is performed in accordance with the following understanding. In the present example, the set consisting of one translation rule to be removed and the subset formed by removing the translation rule naturally form mutually complementary sets.

It is theoretically possible that evaluation corpus 36 is fully translated for every set of rules (subset) in translation rule set storing unit 40, in accordance with the basic understanding. In that case, however, the number of translations would be extremely large. It is impossible to obtain the results in a reasonable time period, unless formidable computation resources are available. Therefore, the amount of computation is reduced in the following manner.

In the machine translation by machine translation engine 42, when one sentence is translated, rules used for the translation can be identified. Such information is stored in translation result storing unit 43. In other words, when evaluation corpus as a whole is translated, it is possible to identify sentences for which each of the rules is used.

When translation is done by machine translation engine using the subset obtained by removing a certain rule from the set of translation rules, the translated sentences that vary because of the removal are only those that have been translated using the rule before the rule is removed. Other sentences are translated using other rules, and therefore, the result of translation of these other sentences do not vary even when translation is done using the set of translation rules with the rule of interest removed.

Therefore, when a certain rule is removed from the set of translation rules, the BLEU score after removal can be obtained by translating only those sentences, which have been translated using the certain rule, by using the set of translation rules with the rule removed, and by calculating similarity between the translation results together with other translations and the corresponding reference translations. It is unnecessary to translate all the sentences.

From the foregoing, it can be seen that by simply removing the translation rule, it becomes possible to obtain results within a reasonable time.

Specifically, rule contribution degree calculating unit 46 obtains the automatic evaluation value before removal provided by translation quality automatic evaluating unit 44 and the information stored in translation result storing unit 43 as to which rule is used for translation (which rule is used for translating which sentence). Rule by rule, automatic evaluation value of the entire translations is calculated when a sentence translated using the rule is re-translated using rules other than the rule. Difference between the thus obtained evaluation value and the automatic evaluation value before removal (automatic evaluation value before removal—evaluation value after removal) is calculated, which difference is regarded as the contribution degree of the rule. Rule contribution degree calculating unit 46 further has a function of applying the rule number of that rule which has, as a result of the above described calculation, a negative degree of contribution (that is, when that rule is removed, degree of contribution becomes higher), to translation rule removing unit 48. In order to speed-up convergence of the process, rule contribution degree calculating unit 46 assumes that the rules to be removed are mutually independent, and therefore, rules to be removed are all determined and removed in one repetition.

More specifically, rule contribution degree calculating unit 46 calculates the degrees of contribution of the rules in the following manner. Among the set of translation rules, for each of the rules used for translation by machine translation engine 42, a set of sentences for which the rule has been used for translation is found. Unless the set of sentences is an empty set, each of the sentences in the set is translated again by machine translation engine 42, using a subset obtained by removing the rule of interest from the original set of rules. Among the results of translation, those obtained by using the rule of interest are replaced by the results of re-translation. Translation quality is again automatically evaluated by translation quality automatic evaluating unit 44. The difference between the evaluation value after removal and the automatic evaluation value before removal is the contribution degree of the translation rule of interest.

The above-described process is performed on every translation rule in translation rule set storing unit 40, and rules having negative degree of contribution are identified. In this manner, translation rules to be removed are determined.

Translation rule removing unit 48 has a function of removing the translation rules that correspond to the information provided by rule contribution degree calculating unit 46, among the rules in translation rule set storing unit 40.

### Operation

Translation rule extracting apparatus 20 in accordance with the first embodiment operates in the following manner. It is assumed that translation corpus 30 and evaluation corpus 36 are prepared beforehand. Translation rule constructing unit 32 automatically constructs translation rules from each of the translation pairs in training corpus 30, which rules are stored in translation rule set storing unit 40.

Machine translation engine 42 translates all the source sentences of the translation pairs contained in evaluation corpus 36, using translation rules stored in translation rule set storing unit 40. The results of translation are stored, together with the information identifying the translation rules used at the time of translation, in translation result storing unit 43.

Translation quality automatic evaluating unit 44 automatically evaluates, as the BLEU score, the translation quality of the translated sentences stored in translation result storing unit 43 using the reference translations stored in evaluation corpus 36, and applies the result of evaluation to rule contribution degree calculating unit 46.

Rule contribution degree calculating unit 46 receives the BLEU score from translation quality automatic evaluating unit 44 as the automatic evaluation value before removal. Thereafter, rule contribution degree calculating unit 46 calculates the rule contribution degree in accordance with the method described above, for each of the translation rules in translation rule set storing unit 40. Rules of which degree of contribution is negative are identified, and the information thereof is applied to translation rule removing unit 48.

Translation rule removing unit 48 removes the rules from the translation rule set stored in translation rule set storing unit 40 in accordance with the information. Thus, the set of translation rules stored in the translation rule set storing unit 40 after the removing process will be the cleaned and optimized set.

### Specific Examples

Specific examples of translations and calculation of rule contribution degree will be described. Here, it is assumed that automatic evaluation value before removal is 0.233363.

### Translation Example 1

Rule 5 of FIG. 2 is an example of an erroneous rule formed from a context-dependent translation. This rule is formed from “the nearest subway station” and “moyorino chikatetsu”, and the translation of “station” in the source language is omitted in Japanese.

When an English sentence “Please tell me where the nearest railway station is” is translated, Rule 5 is applied and a Japanese translation “moyorino tetsudo wa dokoni arimasuka, oshiete itadakemasuka” results.

When Rule 5 is removed, the translation changes to “moyorino tetsudo no eki wa dokoni arimasuka, oshiete itadakemasuka.” The automatic evaluation value after removal attains 0.233549.

Accordingly, degree of contribution of Rule 5 is 0.233363−0.233549=−0.000186. Therefore, Rule 5 is removed. As a result of removal, “the nearest railroad station” comes to be correctly translated to “moyorino tetsudo no eki.”

### Translation Example 2

Rule 6 of FIG. 2 is an example of an erroneous translation formed by an error in automatic construction of translation rules. At the time of automatic construction, “rent two bicycles” is erroneously analyzed to contain a verb phrase of “rent two” and a noun phrase of “bicycles”. Correctly, “rent” is the verb phrase and “two bicycles” is the noun phrase. This sort of error, however, cannot be fully prevented at the time of automatic construction of translation rules.

When an English sentence “I want to rent two rackets” is translated, Rule 6 is applied, and Japanese translation “raketto o 2 karitaino desuga” results. When Rule 6 is removed, the translation changes to “raketto o nihon karitaino desuga” and automatic evaluation value after removal of Rule 6 attains 0.233529. Degree of contribution of Rule 6 is −0.000166, and therefore, Rule 6 is removed.

### Translation Example 3

Rules 7 and 8 of FIG. 2 are examples of rules formed from paraphrases. Though both are correct rules, they are conflicting with each other.

When an English sentence “Please cash this traveler's check” is translated, either Rule 7 or Rule 8 is applied. Assume that Rule 7 is applied in this example. The result of translation is “kono toraverazu chekku o genkin ni shitaino desuga.”

When Rule 7 is removed, the translation changes to “kono toraverazu chekku o genkin ni shite kudasai.” Then, automatic evaluation value after removal attains to 0.233585. This means that translation pairs that match Rule 8 are contained in larger number than translation pairs that match Rule 7 in evaluation corpus 36.

Here, degree of contribution of Rule 7 attains to −0.000222. As a result, Rule 7 is removed, and translations that match expressions more frequently appear in evaluation corpus 36 results.

### Effects of the First Embodiment

In translation rule extracting apparatus 20 in accordance with the first embodiment described above, by the function of feedback cleaning unit 34, the group of translation rules automatically constructed from the bilingual corpus can automatically be cleaned using the translation quality automatic evaluating unit. As a result, translation rules affecting the result of translation are removed, and the quality of translation result of the translation system using the automatically constructed translation rules can be improved. Actually, the results of translation using the translation rules after cleaning attained better evaluation than the results of translation using translation rules before cleaning.

### Computer Implementation

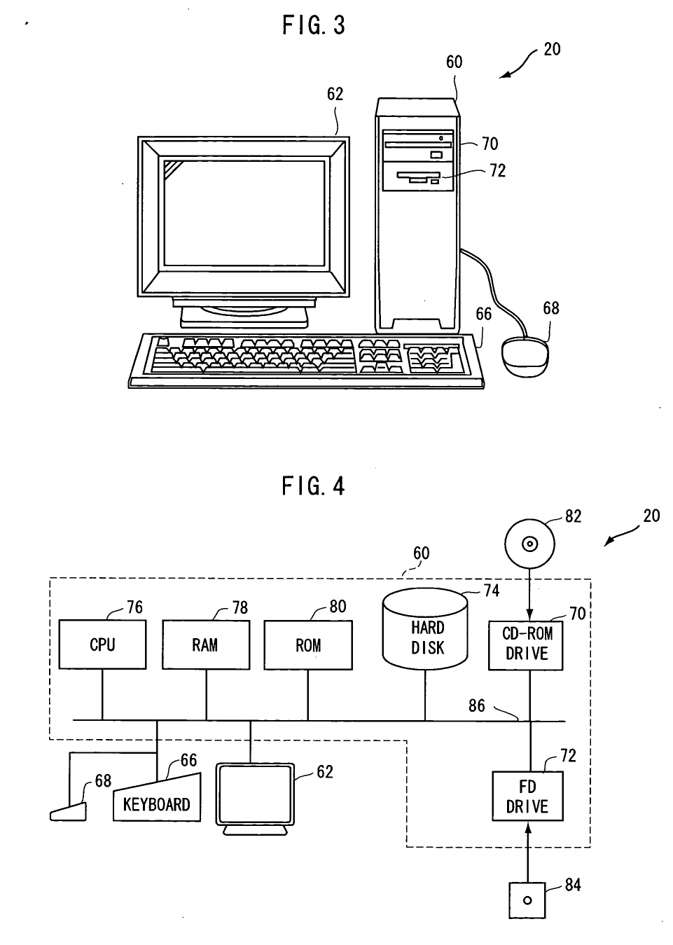

Translation rule extracting apparatus 20 in accordance with the first embodiment described above may be implemented with a computer and software executed thereby. FIG. 3 shows an appearance of a computer used in implementation of the translation rule extracting apparatus 20 and FIG. 4 is a block diagram thereof

Referring to FIG. 3, a computer system constituting the translation rule extracting apparatus 20 includes a computer including a CD-ROM (Compact Disk Read-Only Memory) drive 70, an FD (Flexible Disk) drive 72, and a monitor 62, a keyboard 66 and a mouse 68 that are all connected to computer 60.

Referring to FIG. 4, computer 60 further includes a CPU (Central Processing Unit) 76, a bus 86 connected to CPU 76, and an RAM 78, an ROM 80 and a hard disk 74 that are mutually connected to CPU 76 through bus 86. CD-ROM drive 70 and FD drive 72 are also connected to bus 86. CD-ROM 82 is loaded to CD-ROM drive 70 and FD 84 is loaded to FD drive 72, respectively, enabling data input to/output from CPU 76.

The computer shown in FIGS. 3 and 4 operates as the translation rule extracting apparatus 20 shown in FIG. 1, as it executes a computer program (hereinafter simply referred to as a “program”) having the control structure as will be described in the following. The program is distributed recorded as a computer readable data, for example, on CD-ROM 82. When the CD-ROM 82 is loaded to CD-ROM drive 70, the program is read and stored in hard disk 74, and the computer 60 is ready to execute the program at any time. It is noted that training corpus 30, evaluation corpus 36 and the like are stored in hard disk 74. CPU 76 also reads necessary data from hard disk 74 and stores the data in RAM 78.

When the program is executed, the program stored in hard disk 74 is loaded to ROM 80. CPU 76 reads from ROM 80 and executes an instruction at an address indicated by a program counter, not shown. CPU 76 outputs the result of execution to a prescribed address, and at the same time, updates the contents of the program counter in accordance with the result of execution.

By repeating the above-described process, final set of translation rules results. The result is stored eventually in hard disk 74 in the present embodiment.

As the operation of the computer 60 itself is well-known, detailed description thereof will not be repeated here.

### Program Control Structure

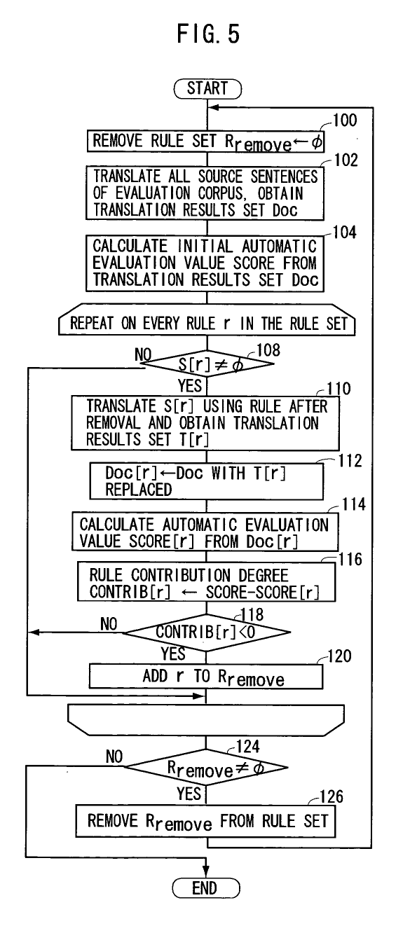

Referring to FIG. 5, the program implementing feedback cleaning unit 34 has the following control structure. First, the program sets a removal rule set Rᵣₑₘₒᵥₑ to an empty set in step 100. In step 102, using machine translation engine 42, all the sentences in the source language of evaluation corpus 36 are translated with reference to the translation rules in translation rule set storing unit 40, and a set of translation results Doc is obtained. At this time, which rule was used for translation is also recorded. Based on this record, a set of source sentences that have been translated using a certain rule r is found. This set of source sentences for the rule r will be denoted by S[r]. Thereafter, in step 104, from the set of translation results Doc, the initial automatic evaluation value (before removal) SCORE is calculated using translation quality automatic evaluating unit 44.

Thereafter, the process of steps 108 to 120 is repeated for every translation rule r in translation rule set storing unit 40. First, in step 108, whether the set of source sentences S[r] for which rule r was used is an empty set or not is determined. If the set is empty, no operation is performed on the rule r. If the set S[r] is not empty, the control proceeds to step 110.

In step 110, all the source sentences included in the set S[r] are machine-translated by machine translation engine 42, using the translation rule set with the rule r removed. The set of resulting translations will be denoted by T[r]. In the next step 112, a new set of translation result Doc[r] is obtained, by replacing, with the set T[r], the set of sentences translated by using the rule r in the set of translation results Doc obtained in step 102. In step 114, automatic evaluation value SCORE[r] is calculated by translation result automatic evaluating unit 44 for the set of translation results Doc[r]. The automatic evaluation value SCORE[r] is the automatic evaluation value after removal. In step 116, the automatic evaluation value after removal SCORE[r] is subtracted from the initial automatic evaluation value SCORE, and the result is input to the rule contribution degree CONTRIB[r].

In step 118, whether the rule contribution degree CONTRIB[r] is negative or not is determined. If the rule contribution degree CONTRIB[r] is negative, the control proceeds to step 120, and the rule r is added to the removal rule set Rᵣₑₘₒᵥₑ. If rule contribution degree CONTRIB[r] is not negative, no operation is done on that rule.

The process of steps 108 to 120 is repeated for every rule r, and thereafter, the control proceeds to step 124. In step 124, whether the removal rule set Rᵣₑₘₒᵥₑ is not empty is determined. If the set Rᵣₑₘₒᵥₑ is empty, execution of the program is terminated. If the set Rᵣₑₘₒᵥₑ is not empty, rules included in the set Rᵣₑₘₒᵥₑ are removed from the set of translation rules contained in translation rule set storing unit 40 in step 126. Thereafter, the control returns to the first step 100, and the process described above is repeated until the removal rule set Rᵣₑₘₒᵥₑ is determined to be an empty set in step 124.

By executing the program having such a control structure by computer 60 shown in FIGS. 3 and 4, the translation rule extracting apparatus 20 in accordance with the first embodiment shown in FIG. 1 can be implemented.

### Modification

In the first embodiment described above, the rule contribution degree of every rule is calculated and whether the rule is to be removed or not is determined thereby. It is unnecessary to perform such a process for each and every translation rule, and the process performed on only a part of the rules may attain some positive effects. When the rule contribution degree is calculated for every translation rule and determination as to the removal is made on the result of calculation, however, the possibility of redundant rules left in the finally resulting translation rules clearly becomes lower. Therefore, it is desired that the above-described process be performed on each and every translation rule.

In the embodiment described above, the rule contribution degree is calculated for each rule, one at a time. By this approach, it becomes possible to determine whether the rule should be removed or not one by one, and therefore, such an approach is preferred for optimizing the translation knowledge. Such a one-by-one determination for the translation rules, however, is not indispensable. In principle, it is possible to assume a case where a plurality of translation rules are removed at one time and degree of contribution of the rules are calculated, and that the plurality of rules are removed collectively in accordance with the result of calculation. Such an approach may also attain to some extent the effects of the above-described embodiment.

The number of translation rules for which determination as to the removal is made is fixed to one in the embodiment above. By fixing the number in this manner, the process is simplified, and therefore, in most cases, the present invention will be implemented in this manner. The number, however, need not be always the same. A number of translation rules determined in accordance with some standard on a case-by-case basis may be processed and the degree of contribution of the rules may be determined.

A basic framework of the present invention is as follows: an arbitrary subset of a set of translation rules (an arbitrary combination of translation rules among initial translation rules) is taken out; it is confirmed which subset should be used for machine translation to attain the highest evaluation value of the translation quality for the translation result; and according to the result of confirmation, the final set of translation rules is determined. The first embodiment above is an example that aims to obtain a fairly satisfactory set of basic rules efficiently while saving computation resources within the basic framework. It would be easily understood by a person skilled in the art that embodiments different in details from the first embodiment are also possible in the basic framework and that such embodiments may be readily made based on the detailed description of the first embodiment above.

### Second Embodiment

### Overview

By using the set of translation results cleaned by the apparatus of the first embodiment, translation quality can fairly be improved. There is, however, still a room for further improvement. According to the first embodiment, it is necessary to prepare an evaluation corpus separately from the training corpus. The evaluation corpus, however, requires reference translations for the source sentences. Therefore, separate preparation of the evaluation corpus should desirably be eliminated.

Generally, the evaluation corpus is in many cases smaller in size than the training corpus. Therefore, even when a global optimal solution can be found, all the rules thereof cannot be tested by the evaluation corpus, possibly resulting in incomplete cleaning. Such an incomplete cleaning should desirably be avoided.

In view of the foregoing, in the apparatus in accordance with the second embodiment, the result of cleaning obtained by feedback cleaning unit 34 used in the first embodiment is cleaned to attain better solution, based on an idea similar to cross validation. In the present specification, such a manner of cleaning will be referred to as “cross cleaning.”

Generally, an “N-fold cross validation” refers to a method in which the data set is divided into approximately equal N sub-data sets, one is used for model parameter estimation, and the remaining data sets are used for evaluating how well the estimated model fits, and such process is performed for every one of N sub-data sets. By such a cross cleaning, the aforementioned incomplete cleaning can be prevented.

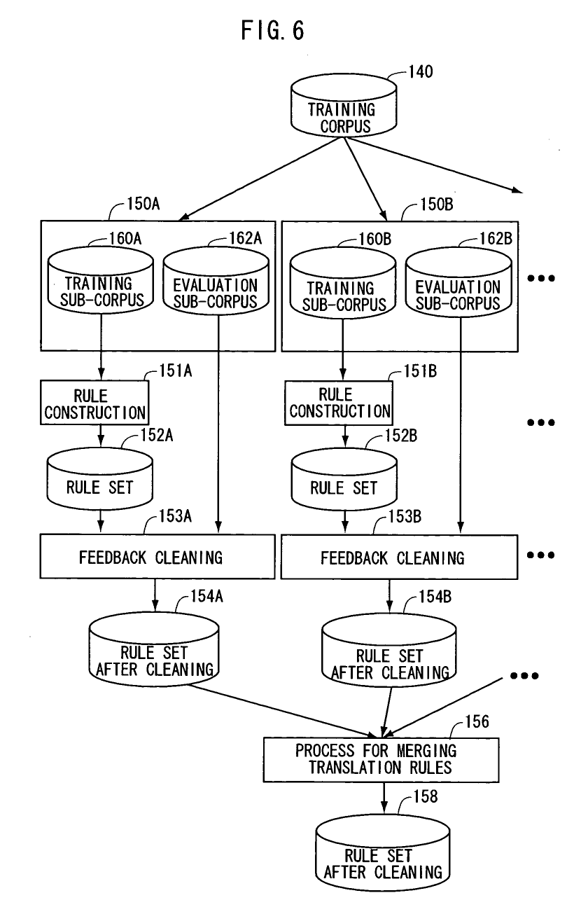

FIG. 6 shows an outline of the cross cleaning performed in the present embodiment, which will be discussed in the following.

Step 1. Training corpus 140 is divided into N.

Step 2. N sub-corpora obtained by the division will be denoted as evaluation sub-corpus 162A, 162B, . . . . N−1 sub-corpora (for evaluation sub-corpus 162A, sub-corpora 162B, 162C, . . . ) with one evaluation sub-corpus (by way of example, evaluation sub-corpus 162A) removed from the original training corpus 140 are put together to form a training sub-corpus 160A. Evaluation sub-corpus 162A and training sub-corpus 160A are paired.

Similarly, for each of the evaluation sub-corpora 162B, 162C, . . . , training sub-corpora 160B, 160C, . . . are formed, and these are paired with the original evaluation sub-corpora 162B, 162C, . . . , respectively.

As a result of the process described above, N pairs of sub-corpora 150A, 150B, . . . are formed. From each of the training sub-corpora 160A, 160B, . . . included in N pairs of sub-corpora 150A, 150B, . . . , translation rules are automatically constructed as 151A, 151B, . . . in the similar manner as in the first embodiment. In this manner, N automatically constructed sets of translation rules 152a, 152B , . . . result.

Step 3. Further, the automatically constructed sets of translation rules 152A, 152B, . . . are subjected to feedback cleaning as in the first embodiment, using respective evaluation sub-corpora 162A, 162B, . . . As a result, N sets of rules after cleaning 154A, 154B, . . . are obtained.

Step 4. Finally, a process of converging machine translation rules 156 is performed on N sets of rules after cleaning 154A, 154B, . . . , to form a final, cross-cleaned set of translation rules 158.

A difference from the conventional cross validation resides in Step 4. In the present embodiment, total sum of the rule contribution degrees is calculated rule by rule, and the rule is output to the final set of translation rules only when the total sum is not smaller than 0. In other words, any rule of which total sum of rule contribution degrees is smaller than 0 is removed from the set of translation rules.

### Configuration

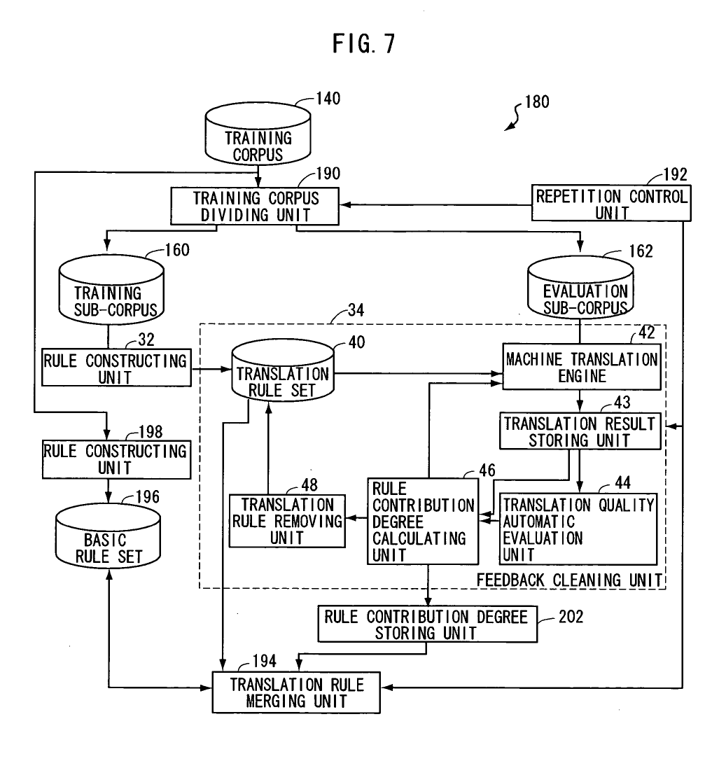

FIG. 7 is a functional block diagram of a translation rule extracting apparatus 180 in accordance with the second embodiment. Referring to FIG. 7, translation rule extracting apparatus 180 includes a training corpus 140, a rule constructing unit 198 for automatically constructing translation rules from training corpus 140, and a basic rule set storing unit 190 for storing the set of translation rules automatically constructed by rule constructing unit 198 (referred to as “basic set of translation rules”). Rule constructing unit 198 has the same function as rule constructing unit 32 used in the first embodiment.

Translation rule extracting apparatus 180 further includes: a training corpus dividing unit 190 having a function of dividing training corpus 140 into N sub-corpora to provide an evaluation sub-corpus 162 consisting of one of the N-divided corpora and one training sub-corpus 160 consisting of remaining N−1 sub-corpora; a rule constructing unit 32 for automatically constructing translation rules from training sub-corpus 160; and a feedback cleaning unit 34 for feedback cleaning the set of translation rules output from rule constructing unit 32 using evaluation sub-corpus 162 in the similar manner as in the first embodiment. Functions of feedback cleaning unit 34 and various components thereof are the same as those of the first embodiment, and therefore, detailed description thereof will not be repeated here.

Translation rule extracting apparatus 180 further includes a repetition control unit 192 for controlling training corpus dividing unit 190, rule constructing unit 32 and feedback cleaning unit 34 such that automatic construction of translation rules by rule constructing unit 32 and feedback cleaning of translation rules by feedback cleaning unit 34 are executed repeatedly for N times. Repetition by repetition control unit 192 is done while evaluation sub-corpus 162 selected by training corpus dividing unit is switched one by one.

In addition, translation rule extracting apparatus 180 includes: a rule contribution degree storing unit 202 for string, for every rule and for every repetition, the rule contribution degree calculated by rule contribution degree calculating unit 46 of feedback cleaning unit 34; and a translation rule merging unit 194 for forming one final set of cross-cleaned translation rules in a basic rule set storing unit 196, by merging N sets of translation rules that have been subjected to feedback cleaning provided by rule constructing unit 32 and feedback cleaning unit 34. Translation rule merging unit 194 removes unnecessary rule or rules from the basic set of translation rules stored in basic translation rule set storing unit 196 using the rule contribution degree of each rule and each repetition stored in rule contribution degree storing unit 202, so as to merge the rules.

Functions of rule constructing unit 32 and feedback cleaning unit 34 are the same as those described with reference to the first embodiment.

Training corpus dividing unit 190 divides training corpus 140 in different manner at every repetition as will be described below. First, training corpus 140 is divided approximately equally into N sub-corpora as described above. The results will be referred to as the first sub-corpus, second sub-corpus, . . . Nth sub-corpus, respectively.

In the first turn of repetition, training corpus dividing unit 190 sets the first sub-corpus as evaluation sub-corpus 162 and the second to Nth sub-corpora collectively as training sub-corpus 160. In the second turn, training corpus dividing unit 190 sets the second sub-corpus as evaluation sub-corpus 162 and the first and third to Nth sub-corpora collectively as training sub-corpus 160. In the third turn, training corpus dividing unit 190 sets the third sub-corpus as evaluation sub-corpus 162 and the first, second and fourth to Nth sub-corpora collectively as training sub-corpus 160. Thereafter, the process proceeds in the similar manner, and in Nth turn of repetition, training corpus dividing unit 190 sets the Nth sub-corpus as evaluation sub-corpus 162 and sets the first to N-1th sub-corpora collectively as training sub-corpus 160.

This is the function of training corpus dividing unit 190.

Translation rule merging unit 194 merges the translation rules after feedback cleaning in the following manner. By rule constructing unit 198, the basic set of translation rules is automatically constructed from the entire training corpus 140. The basic set of translation rules is stored in basic rule set storing unit 196.

Thereafter, by N times of feedback cleaning by repetition control unit 192, N sets of translation rules are obtained from N training sub-corpora 160 of training corpus 140. These will be referred to as the first set of translation rules, second set of translation rules, . . . , and Nth set of translation rules, respectively. The rule contribution degree of each rule calculated by rule contribution degree calculating unit 46 when these sets of translation rules are formed are stored separately turn by turn of repetition in rule contribution degree storing unit 202. The rule contribution degree of rule r for ith turn of repetition is represented as CONTRIB[i][r] (1≦i≦N, 1≦r≦ number of basic rules).

When all feedback cleanings are complete, translation rule merging unit 194 calculates, for every translation rule r, total sum CONTRIB[r]=ΣᵢCONTRIB[i][r] of rule contribution degrees stored in rule contribution degree storing unit 202, with reference to rule contribution degree storing unit 202. When the total sum CONTRIB[r] is negative, the rule r is removed from the basic set of translation rules stored in basic rule set storing unit 196. This process is performed on every rule r, and the basic set of rules stored in basic rule set storing unit 196 is cleaned, and the final set of cross-cleaned translation rules is obtained.

### Operation

Translation rule extracting apparatus 140 in accordance with the second embodiment operates in the following manner. It is assumed that training corpus 140 is prepared initially. Further, it is also assumed that the method of approximately equally dividing training corpus 140 into N is determined in advance. First, rule constructing unit 198 automatically constructs translation rules from training corpus 140. The constructed set of translation rules (basic set of rules) is stored in basic rule set storing unit 196.

The following repetition process is executed under the control of repetition control unit 192. First, training corpus dividing unit 190 selects the first sub-corpus from training corpus 140, and sets the same as evaluation sub-corpus 162. Training corpus dividing unit 190 further sets remaining N−1 sub-corpora collectively as training sub-corpus 160. Rule constructing unit 32 automatically constructs translation rules from training sub-corpus 160. The constructed set of translation rules is stored in translation rule set storing unit 40.

Machine translation engine 42 translates a set of source sentences in evaluation sub-corpus 162, using translation rules stored in translation rule set storing unit 40. Translation quality evaluating unit 44 automatically evaluates translation quality of the result of translation by machine translation engine 42, and applies as a score to rule contribution degree calculating unit 46.

Rule contribution degree calculating unit 46 calculates the degree of contribution of each of the rules stored in translation rule set storing unit 40, as described in the first embodiment. The calculated rule contribution degree is stored as CONTRIB[i][r] rule by rule and turn by turn of repetition, in rule contribution degree storing unit 202.

By repeating N times the process described above, degrees of rule contribution CONTRIB[i][r] (1≦i≦N, 1≦r≦ number of basic rules) are stored in rule contribution degree storing unit 202.

Translation rule merging unit 194 calculates, for each of the rules stored in basic rule set storing unit 196, the total sum CONTRIB[r]=ΣiCONTRIB[i][r] of rule contribution degrees, as described above. When CONTRIB[r] is negative, the rule is removed from the basic set of rules in basic rule set storing unit 196.

Translation rule merging unit 196 executes the above-described process on all the translation rules stored in basic rule set storing unit 196, and eventually, basic rule set storing unit 196 comes to have a cross-cleaned basic set of rules.

### Effects of the Second Embodiment

Machine translation was done using the set of translation rules cross-cleaned by translation rule extracting apparatus in accordance with the second embodiment, and better results could be obtained than the first embodiment. In translation rule extracting apparatus 20 in accordance with the first embodiment, it was necessary to prepare an evaluation corpus separately from the training corpus. In translation rule extracting apparatus 180 in accordance with the second embodiment, only the training corpus 140 is used, and it is unnecessary to prepare a separate evaluation corpus. Therefore, cleaning of the translation rules can be performed using a limited bilingual corpus, and using the resulting set of translation rules, highly accurate machine translation becomes possible.

### Computer Implementation

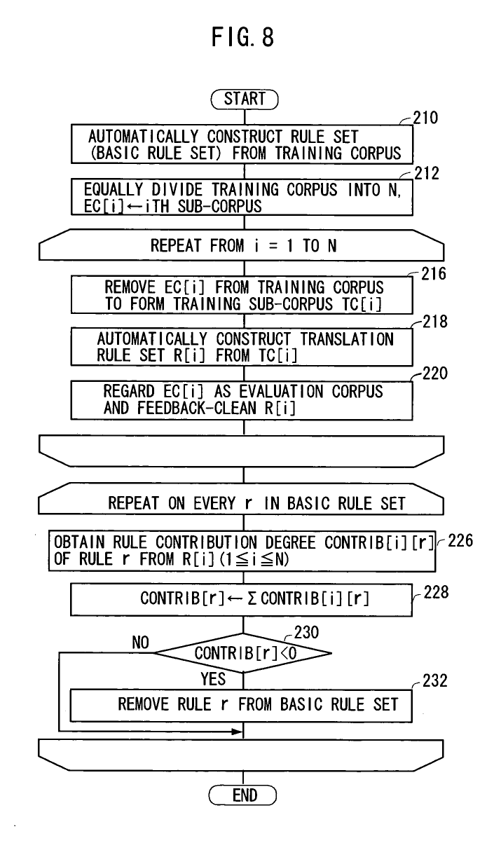

Translation rule extracting apparatus in accordance with the second embodiment can also be implemented by a computer shown in FIGS. 3 and 4 and the program executed thereon. FIG. 8 shows, in a flow chart, a control structure of the program for implementing translation rule extracting apparatus 180 in accordance with the second embodiment.

Referring to FIG. 8, the program includes the step 210 of automatically constructing a basic set of rules from training corpus 140, and the step 212 of classifying training corpus 140 uniformly into N sub-corpora. These N sub-corpora will be represented as EC[i] (1≦i≦N).

The program further includes the step of repeating the following steps 216 to 220 with the variable i changed one by one from 1 to N. In step 216, sub-corpus EC[i] is removed from training corpus 140 to form training sub-corpus 160. The resulting training sub-corpus will be represented as TC[i].

Thereafter, in step 218, a set of translation rule R[i] is automatically constructed from training sub-corpus TC[i]. Further, in step 220, the set of translation rules R[i] is subjected to feedback cleaning, regarding sub-corpus EC[i] as an evaluation corpus. Contents of the feedback control are similar to those of the first embodiment shown in FIG. 5. It is noted, however, that the rule contribution degree CONTRIB[r] calculated in step 116 of FIG. 5 must be stored as CONTRIB[i][r].

After the process from step 216 to step 220 is repeated N times, the process from step 226 to step 232 as will be described in the following is repeated for every rule r in the basic set of rules automatically constructed in step 210 (1≦r< number of rules in the basic set of rules).

In step 226, from the set of translation rules R[i] (1≦i≦N), the rule contribution degree CONTRIB[i][r] is obtained. Specifically, the rule contribution degree stored in step 116 of FIG. 5 is taken out from the storage area, as already described. In step 228, contribution degree of basic rule r CONTRIB[r]=ΣiCONTRIB[i][r] is calculated.

In the following step 230, whether the degree of contribution CONTRIB[r] calculated in step 228 is negative or not is determined. If it is negative, the rule r is removed from the basic set of rules in step 232. If not, no operation is performed.

As already described, by performing the process from step 226 to step 232 on every rule in the basic set of rules, translation rules that have been subjected to cross feedback cleaning can eventually be obtained. By the cross-cleaning, such an incomplete cleaning that has been described in the first part of the second embodiment can be avoided.

### Modification of the Second Embodiment

In the apparatus of the second embodiment described above, rule constructing unit 198 is provided separate from rule constructing unit 32. These units may not be separate units. One rule constructing unit may be used with the destinations of its input and output switched.

Further, in the apparatus of the embodiment described above, a training sub-corpus and an evaluation sub-corpus are prepared by approximately equally dividing the training corpus 140 into N sub-corpora. The present invention, however, is not limited to such an embodiment. For instance, training corpus 140 need not be equally divided. It may be divided into corpora of substantially different sizes, and processes similar to those described above may be performed. In that case, however, it is desirable to multiply each degree of contribution by a weight that reflects the corpus size and to add the thus obtained results, when the total sum of contribution degrees is calculated for merging the rules by translation rule merging unit 194.

### Common Modification

In the two embodiments described above, a machine translation engine described in Reference 2 is used as machine translation engine 42. The present invention, however, is not limited thereto. Any machine translation engine may be used, provided that it is of the syntax transfer type using translation rules.

Further, in the two embodiments described above, BLEU has been used for automatic evaluation of translation quality by translation quality automatic evaluation unit 44. BLEU, however, is not the only option available for automatic evaluation of translation quality, and those described in References 3 and 4 may be used.

As to the automatic evaluation value, in the present embodiment, the evaluation value becomes higher when similarity to the translations in the evaluation corpus is higher. The automatic evaluation value, however, is not limited to this type, and the evaluation value may become lower when the similarity becomes higher. Alternatively, an evaluation value that becomes closer to a specific value when the similarity to the translations in the evaluation corpus becomes higher may be used.

In the embodiments above, translation rules are regarded as translation knowledge, and degree of contribution is calculated for each and every translation rule. The present invention, however, is not limited to such embodiments. For instance, a plurality of translation rules may be selected collectively, and the translation rules included in that sub-set may be collectively subjected to the cleaning described above.

In the embodiments above, a set of a translation rule is selected, and when the degree of contribution of that rule is negative, the translation rule is removed. The present invention, however, is not limited to such embodiments. By way of example, rule contribution degree of a set consisting of translation rules except for one translation rule may be calculated, and when the calculated value is positive, the translation rule belonging to the complementary set of the object set may be removed, to attain the same effect.

The manner of software distribution is not limited to the above-described form that is fixed on a storage medium. By way of example, the software may be distributed by receiving data from another computer connected to a network. Alternatively, part of the software may be stored in hard disk 54, and remaining part of the software may be taken to the hard disk 54 through a network, and these parts may be integrated at the time of execution.

Typically, a current program utilizes common functions provided by the operating system (OS) of a computer, and executes these functions in a systematic manner in accordance with the desired object, so as to attain the desired objects described above. Therefore, even a program or programs that do not include, among the functions of the embodiments described above, common functions provided by the OS or a third party but simply designate the order of execution of such common functions are clearly within the scope of the present invention as long as the program or programs as a whole have a control structure that attains the desired object utilizing these general functions.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### List of References

[Reference 1] Paineni, K., Roukos, S., Ward, T., and Zhu, W. -J. (2002) Bleu: a method for automatic evaluation of machine translation. In Proceedings of the 40th Annual Meeting of the Association for Computational Linguistics (ACL), pp. 311-318.

[Reference 2] Osamu Furuse, Kazuhide Yamamoto and Setsuo Yamada, (1999). Using Constituent Boundary Parsing for Multi-lingual Spoken-language Translation, Shizen gengo shori, 6(5):63-91

[Reference 3] Yasuda, K., Sugaya, F., Takezawa, T., Yamamoto, S., and Yanagida, M.,(2001). An automatic evaluation method of translation quality using translation answer candidates queried from a parallel corpus. In Proceedings of Machine Translation Summit VIII, pp. 373-378.

[Reference 4] Akiba Y., Imamura K., and Sumita, E., (2001). Using multiple edit distances to automatically rank machine translation output. In Proceedings of Machine Translation Summit VIII, pp. 15-20.

What is claimed is:

1. A method of improving translation knowledge for machine translation from a first language to a second language using a computer, comprising the steps of:
preparing, in a storage device, a set of computer readable translation knowledge;
preparing, in a storage device, a bilingual corpus including a plurality of computer readable translation pairs of said first language and said second language;
machine-translating each of sentences of said first language in said bilingual corpus to said second language using said set of translation knowledge;
automatically evaluating translation quality of said second language obtained as a result of said step of machine translation in accordance with a prescribed evaluation standard with reference to said bilingual corpus, thereby calculating an evaluation value;
for a sub-set of said set of translation knowledge, calculating degree of contribution of said subset to the translation quality, using a record related to the translation knowledge used for translating each sentence in said step of machine translation and using said evaluation value; and
removing translation knowledge having a prescribed relation with said subset from said set of translation knowledge, when the degree of contribution calculated in said step of calculating degree of contribution satisfies a prescribed condition.

2. The method according to claim 1, wherein
said step of calculating degree of contribution includes the step of calculating a difference between the evaluation value calculated in said step of calculating evaluation value and an evaluation value of translation quality when each of the sentences of said first language in said bilingual corpus is translated using a complementary set of said subset related to said set of translation knowledge.

3. The method according to claim 2, wherein
said step of machine translation includes the step of translating each of the sentences of said first language in said bilingual corpus to said second language while generating a record of translation knowledge used for translating each sentence; and
said step of calculating a difference includes the steps of
based on the record of translation knowledge used for translating each sentence generated in said step of machine translation, identifying a sentence of said first language translated using translation knowledge included in said subset in said step of machine translation and identifying translation of the sentence translated in said step of machine translation,
re-translating each of the sentences of said first language identified in said identifying step, by machine translation using translation knowledge included in a complementary set of said subset related to said set of translation knowledge,
calculating a re-evaluation value by automatically evaluating, in accordance with said prescribed evaluation standard, a set of translations obtained by replacing the translations of the first language identified in said identifying step with the translations resulting from said re-translation step in the set of translations obtained by said step of machine-translation, and
calculating a difference between the evaluation value calculated in said step of calculating evaluation value and said re-evaluation value calculated in said step of calculating re-evaluation value.

4. The method according to claim 1, wherein
said step of removing translation knowledge includes the step of removing the translation knowledge included in said subset from said set of translation knowledge, when the degree of contribution calculated in said step of calculating degree of contribution is a negative value.

5. The method according to claim 1, further comprising the step of:
repeating, until a prescribed terminating condition is satisfied, said step of calculating degree of contribution and said step of removing, while changing said subset among said set of translation knowledge.

6. The method according to claim 5, wherein
said subset includes only one translation knowledge.

7. The method according to claim 1, wherein
said translation knowledge includes a syntax transfer rule from a syntax pattern of said first language to a syntax pattern of said second language.

8. The method according to claim 1, wherein
said step of calculating degree of contribution includes the steps of
forming a plurality of subsets from said set of translation knowledge in accordance with a prescribed method,
re-translating sentences of said first language in said bilingual corpus using a machine translation engine similar to one used in said step of machine translation using each of said plurality of subsets, and calculating re-evaluation value of translation quality of the result of said re-translation in accordance with said prescribed evaluation standard, and
for each of said plurality of subsets, calculating a difference between the evaluation value calculated in said step of calculating evaluation value and the re-evaluation value calculated in said step of calculating re-evaluation value.

9. The method according to claim 8, wherein
said step of removing includes the steps of
for each of said plurality of subsets, determining whether the degree of contribution calculated in said step of calculating degree of contribution is a negative value or not, and
for each of the subsets of which degree of contribution is determined to be a negative value in said step of determining, removing the translation knowledge belonging to that subset from said set of translation knowledge.

10. The method according to claim 9, wherein
said step of machine translation includes the step of translating each of the sentences of said first language in said bilingual corpus to said second language while generating a record of translation knowledge used for translating each sentence; and
said step of calculating a difference includes the steps of
based on the record of translation knowledge used for translating each sentence generated in said step of machine translation, identifying a sentence of said first language translated using translation knowledge included in said subset in said step of machine translation and identifying translation of the sentence translated in said step of machine translation,
re-translating each of the sentences of said first language identified in said identifying step, by machine translation using translation knowledge included in said subset,
calculating a re-evaluation value by automatically evaluating, in accordance with said prescribed evaluation standard, a set of translations obtained by replacing the translations of the first language identified in said identifying step with the translations resulting from said re-translation step in the set of translations obtained by said step of machine-translation, and
calculating a difference between the evaluation value calculated in said step of calculating evaluation value and said re-evaluation value calculated in said step of calculating re-evaluation value.

11. The method according to claim 9, wherein
said step of removing includes the steps of
for each of said plurality of subsets, determining whether the difference calculated in said step of calculating a difference is a positive value or not, and
removing, for each of the subsets of which difference is determined to be a positive value in said step of determining, the translation knowledge belonging to a complementary set from the set of translation knowledge.

12. The method according to claim 9, wherein
said step of forming subsets includes the step of forming a plurality of subsets by removing a predetermined number of translation knowledge from said set of translation knowledge.

13. The method according to claim 12, wherein
said step of forming a plurality of subsets includes the step of forming a plurality of subsets obtained by removing one translation knowledge from said set of translation knowledge.

14. The method according to claim 9, wherein
said step of forming subsets includes the step of forming all subsets that can be obtained by removing a prescribed number of translation knowledge from said set of translation knowledge.

15. The method according to claim 1, further comprising the steps of:
forming, from a computer readable training corpus including translation pairs of said first and second languages prepared in advance, a plurality of sub-corpus pairs each including a training sub-corpus and an evaluation sub-corpus;
automatically constructing translation rules from each of said plurality of sub-corpus pairs, in accordance with a predetermined method of constructing translation rules;
storing, in a storage device, a set of a plurality of translation rules constructed for said plurality of sub-corpus pairs in said constructing step, as basic translation knowledge for said plurality of sub-corpora;
performing, for each of said plurality of sub-corpus pairs, using each of said plurality of sub-corpus pairs as said bilingual corpus and using the set of translation rules obtained in said step of constructing from the corresponding sub-corpus as said translation knowledge, the steps of preparation, machine-translation, calculating evaluation value, calculating degree of contribution and removal, so as to improve said translation knowledge; and
merging sets of translation knowledge obtained for each of said plurality of sub-corpus pairs improved in said step of improving translation knowledge, to one set of translation knowledge.

16. The method according to claim 15, wherein
said step of merging includes the steps of
for each of the translation rules included in said basic translation knowledge stored in said storage device, summing the degree of contribution calculated in said step of calculating degree of contribution over all said plurality of sub-corpus pairs, and
updating said basic translation knowledge stored in said storage device such that a translation rule of which degree of contribution summed in said step of summing satisfies a prescribed condition is removed.

17. The method according to claim 16, wherein
said step of updating said basic translation knowledge includes the step of updating said basic translation knowledge stored in said storage device such that a translation rule of which degree of contribution summed in said step of summing is negative.

18. A storage medium storing a computer program that causes, when executed by a computer, said computer to execute all the steps recited in claim 1.

19. An apparatus for improving translation knowledge for machine translation, comprising:
translation knowledge storing means for string a set of translation knowledge;
means for storing a machine readable bilingual corpus including a plurality of translation pairs in a source language and a target language;
machine translation means for machine-translating sentences of said source language in said bilingual corpus to said target language, utilizing said set of translation knowledge stored in said translation knowledge storing means;
translation quality automatic evaluation means for automatically evaluating translation quality of the result of translation by said machine translation means with reference to said bilingual corpus, and for outputting an evaluation value; and
improving means for improving said set of translation knowledge such that the evaluation value output by said translation quality automatic evaluation means changes desirably.

20. The apparatus according to claim 19, wherein
said translation knowledge includes a syntax transfer rule from a syntax pattern of said source language to a syntax pattern of said target language.

21. The apparatus according to claim 19, wherein
said improving means includes
means for calculating, for each of the translation knowledge included in said set of translation knowledge, degree of contribution of the rule, and
means for removing a translation rule of which degree of contribution satisfies a predetermined condition from said set of translation knowledge.

22. The apparatus according to claim 21, wherein
said means for calculating degree of contribution of the rule includes
means for causing said machine translation means to translate and said translation quality automatic evaluation means to evaluate translation quality of the result of translation using entire said set of translation knowledge, for obtaining an initial evaluation value,
means for causing, for every translation knowledge in said set of translation knowledge, said machine translation means to translate and said translation quality automatic evaluation means to evaluate translation quality of the result of translation using a subset obtained by removing the translation knowledge of interest from said set of translation knowledge, for obtaining an evaluation value after removal, and
means for calculating a difference between said evaluation value after removal and said initial evaluation value as said degree of contribution of the rule of said certain translation knowledge.

23. The apparatus according to claim 19, wherein
said improving means includes
means for causing said machine translation means to translate and said translation quality automatic evaluation means to evaluate translation quality of the result of translation using entire said set of translation knowledge, for obtaining an initial evaluation value,
means for forming a plurality of subsets from said set of translation knowledge in accordance with a prescribed method,
determining means for causing said machine translation means to translate and said translation quality automatic evaluation means to evaluate translation quality of the result of translation using each of said plurality of subsets, and for determining whether the evaluation value satisfies a prescribed condition with respect to the initial evaluation value, and,
means for removing, for each of the subsets of which evaluation value is determined by said determining means as satisfying said prescribed condition, translation knowledge belonging to a complementary set from said set of translation knowledge.

24. The apparatus according to claim 23, wherein
said means for forming subsets includes means for forming a plurality of subsets obtained by removing a predetermined number of translation knowledge from said set of translation knowledge.

25. The apparatus according to claim 24, wherein
said means for forming a plurality of subsets includes means for forming a plurality of subsets obtained by removing one translation knowledge from said set of translation knowledge.

26. The apparatus according to claim 23, wherein
said means for forming subsets includes means for forming all possible subsets that can be obtained by removing a predetermined number of translation knowledge from said set of translation knowledge.

27. The apparatus according to claim 23, wherein
said machine translation means includes means for outputting information as to which translation knowledge in said set of translation knowledge is used for machine translating a sentence of the source language;
said translation knowledge improving apparatus further comprising
means for storing, for each sentence translated to obtain said initial evaluation value, the information identifying the translation knowledge used for translation output from said machine translation means; wherein
said determining means includes
means for identifying, for each of said plurality of subsets, a set of sentences of said source language that has been translated using the translation knowledge included in a complementary set of the subset, referring to the information identifying said translation knowledge stored in said storing means,
means for machine translating again, using each of said subsets, said set of sentences of the source language that has been translated using translation knowledge included in the complementary set of the subset, by said machine translating means,
means for replacing, for each of said subsets, a result of translation translated using the translation knowledge included in the complementary set of the subset among said initial translation results with a result of translation by said means for machine translating again, causing said translation quality automatic evaluation means to evaluate translation quality of the initial translation results after replacement, for obtaining an evaluation value of the translation result by the subset, and
means for determining, for each of said subsets, whether the evaluation value of the translation result by the subset satisfies said prescribed condition with respect to said initial evaluation value.

28. The apparatus according to claim 27, wherein
said determining means includes means for determining, for each of said subsets, whether the evaluation value of the translation result by the subset exceeds said initial evaluation value.

29. The apparatus according to claim 19, further comprising:
means for forming, from a training corpus consisting of translation pairs of said source language and said target language prepared in advance, a plurality of sub-corpus pairs each including a training sub-corpus and an evaluation sub-corpus;
translation knowledge automatic constructing means for automatically constructing translation knowledge from a given bilingual corpus, in accordance with a predetermined method of constructing translation knowledge;
basic translation knowledge storing means causing said translation knowledge automatic constructing means to automatically construct translation knowledge from said training corpus and for storing as basic translation knowledge;
means for causing, for each of said plurality of sub-corpus pairs, said translation knowledge automatic constructing means to automatically construct a set of translation knowledge from said training corpus, and for performing, on the set of translation knowledge, using said evaluation sub-corpus as said machine readable bilingual corpus, improvement by said translation knowledge storing means, said means for storing machine readable bilingual corpus, said machine translation means, said translation quality automatic evaluation means and said improving means; and
means for merging sets of translation knowledge obtained for respective ones of said plurality of sub-corpus pairs improved by said means for performing improvement into one set of translation knowledge.

30. The apparatus according to claim 29, wherein
said merging means includes
difference summation means for summing difference calculated by said improving means for each of the translation knowledge included in said basic translation knowledge stored in said basic translation knowledge storing means, over all said plurality of sub-corpus pairs, and
means for updating said basic translation knowledge stored in said basic translation knowledge storing means such that a translation knowledge of which difference summed by said difference summation means satisfies a prescribed condition.

31. The apparatus according to claim 30, wherein
said means for updating said basic translation knowledge includes means for updating said basic translation knowledge stored in said basic translation knowledge storing means such that a translation knowledge of which difference summed by said difference summation means is negative.

32. The apparatus according to claim 29, wherein
said means for forming a plurality of sub-corpus pairs includes
means for substantially equally dividing said training corpus into a predetermined number for forming evaluation sub-corpora of said predetermined number, and
means for forming, for each of said predetermined number of evaluation sub-corpora, a corpus by removing the evaluation sub-corpus from said training corpus, for forming a training sub-corpus to be paired with said evaluation sub-corpus.
